(19) United States
(12) Patent Application Publication
(10) Pub. No.: US 2017/0285176 A1
(43) Pub. Date: Oct. 5, 2017

(54) SYSTEMS AND METHODS FOR LOCATING A VEHICLE

(71) Applicant: GM GLOBAL TECHNOLOGY OPERATIONS LLC, Detroit, MI (US)

(72) Inventors: STEVEN R. CROYLE, BINGHAM FARMS, MI (US); CURTIS L. HAY, WEST BLOOMFIELD, MI (US); PAUL K. WAGNER, NOVI, MI (US); SHINGARA S. DHANOA, OVERLAND PARK, KS (US); ERAY YASAN, CANTON, MI (US); HERBERT PFEIFFER, HARRISON TOWNSHIP, MI (US)

(73) Assignee: GM GLOBAL TECHNOLOGY OPERATIONS LLC, Detroit, MI (US)

(21) Appl. No.: 15/087,019

(22) Filed: Mar. 31, 2016

(51) Int. Cl. G01S 19/40; G05D 1/02; G01S 19/42; G01C 21/26

(52) U.S. Cl. CPC G01S 19/40; G01C 21/26; G05D 1/0278; G01S 19/42

(57) ABSTRACT

Methods and systems are provided for locating a vehicle. A locating device receives position data and determines an approximate position of the vehicle. A remote server reports a plurality of corrections factor for a respective plurality of locations which are buffered by a transmission server into a burst transmission. The transmission server transmits the burst transmission of the correction factors over a wireless data channel. A receiver receives the burst transmission from the transmission server and a correction device extracts a selected correction factor from the burst transmission based on the approximate position to determine a refined position of the vehicle.

### TECHNICAL FIELD

The technical field generally relates to positioning systems, and more particularly relates to methods and systems for locating a vehicle by delivering a burst transmission of correction factors to the vehicle.

### BACKGROUND

Vehicle locating systems are used to identify vehicle position for use in vehicle navigation systems. Current systems make use of Global Positioning Systems (GPS) to locate the vehicle relative to roads, points of interest (POI), and other features commonly found on maps. More generally, GPS is typically augmented with additional satellite navigation systems that operate in various countries and regions including Global Navigation Satellite System (GLONASS), Galileo Satellite Navigation, Beidou Navigation Satellite System, and Quasi-Zenith Satellite System (QZSS). The general term for using multiple constellations to compute a location is Global Navigation Satellite Systems (GNSS). Consumer GNSS systems are generally accurate to ten to fifty feet ninety five percent of the time, which is sufficient for general navigation purposes. However, this is not sufficiently accurate to perform more advanced vehicle control that requires precise identification of vehicle position relative to other vehicles on the road.

Precise Point Positioning (PPP) satellite navigation uses instantaneous state corrections that are broadcasted for all satellite signals available to a device employing GNSS to allow for improved locating accuracy of a GNSS. These correction factors are continually updated and a GNSS must have up to date correction factors in order to perform PPP navigation. Conventionally, correction factors are broadcasted in a continuous data stream that is updated as newer correction factors become available.

Accordingly, it is desirable to provide systems and methods for locating a vehicle that provides a GNSS with correction factors in a manner that is more efficient and effective than is currently being employed. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for locating a vehicle. In one non-limiting example, a system for locating a vehicle includes, but is not limited to, a locating device adapted for mounting to the vehicle, the locating device being configured to receive position data and to determine an approximate position of the vehicle when mounted thereto. The system further includes, but is not limited to, a remote server that is configured to report a plurality of correction factors for a respective plurality of locations. The system further includes, but is not limited to, a transmission server that is configured to buffer the plurality of correction factors into a burst transmission and to transmit the burst transmission over a wireless data channel. The system further includes, but is not limited to, a receiver adapted for mounting to the vehicle, the receiver being configured to receive the burst transmission from the transmission server over the wireless data stream. The system further includes, but is not limited to, a correction device adapted for mounting to the vehicle, the correction device being configured to extract a selected correction factor from the burst transmission based on the approximate position and to determine a refined position of the vehicle based on the selected correction factor and the approximate position.

In another non-limiting example, a vehicle includes, but is not limited to, a telematics control unit having a locating device that is configured to receive position data and to determine an approximate position of the vehicle. The telematics control unit further includes, but is not limited to, a receiver that is configured to receive a burst transmission from a transmission server, the burst transmission buffered with a plurality of correction factors for a respective plurality of locations. The telematics control unit further includes, but is not limited to, a correction device configured to extract a selected correction factor from the burst transmission based on the approximate position and to determine a refined position of the vehicle based on the selected correction factor and the approximate position.

In another non-limiting example, a method is provided for locating a vehicle. The method includes, but is not limited to, receiving position data with a locating device on the vehicle and determining an approximate position of the vehicle based on the position data. The method further includes, but is not limited to, buffering a plurality of correction factors into a burst transmission with a transmission server, the plurality of correction factors each corresponding to a respective plurality of locations. The method further includes, but is not limited to, transmitting the burst transmission with the transmission server. The method further includes, but is not limited to, receiving the burst transmission with a receiver on the vehicle. The method further includes, but is not limited to, extracting a selected correction factor from the burst transmission based on the approximate position and determining a refined position of the vehicle with a correction device on the vehicle. The refined position of the vehicle is based on the selected correction factor and the approximate position.

### DESCRIPTION OF THE DRAWINGS

The disclosed examples will hereinafter be described in conjunction with the following drawing figures, wherein like numerals denote like elements, and wherein:

FIG. 1 is a diagram illustrating a non-limiting example of a communication system;

FIG. 2 is diagram illustrating a non-limiting example of a system for locating a vehicle according to an embodiment;

FIG. 3 is diagram illustrating a non-limiting example of a system for locating a vehicle according to an embodiment;

FIG. 4 is a diagram illustrating a non-limiting example of the operation of the systems of FIGS. 2 and 3 for locating a vehicle according an embodiment;

FIG. 5 is a diagram illustrating a non-limiting example of the operation of the systems of FIGS. 2 and 3 for locating a vehicle according an embodiment;

FIG. 6 is a diagram illustrating a non-limiting example of the operation of the systems of FIGS. 2 and 3 for locating a vehicle according an embodiment; and

FIG. 7 is a flowchart illustrating a non-limiting example of a method for locating a vehicle.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

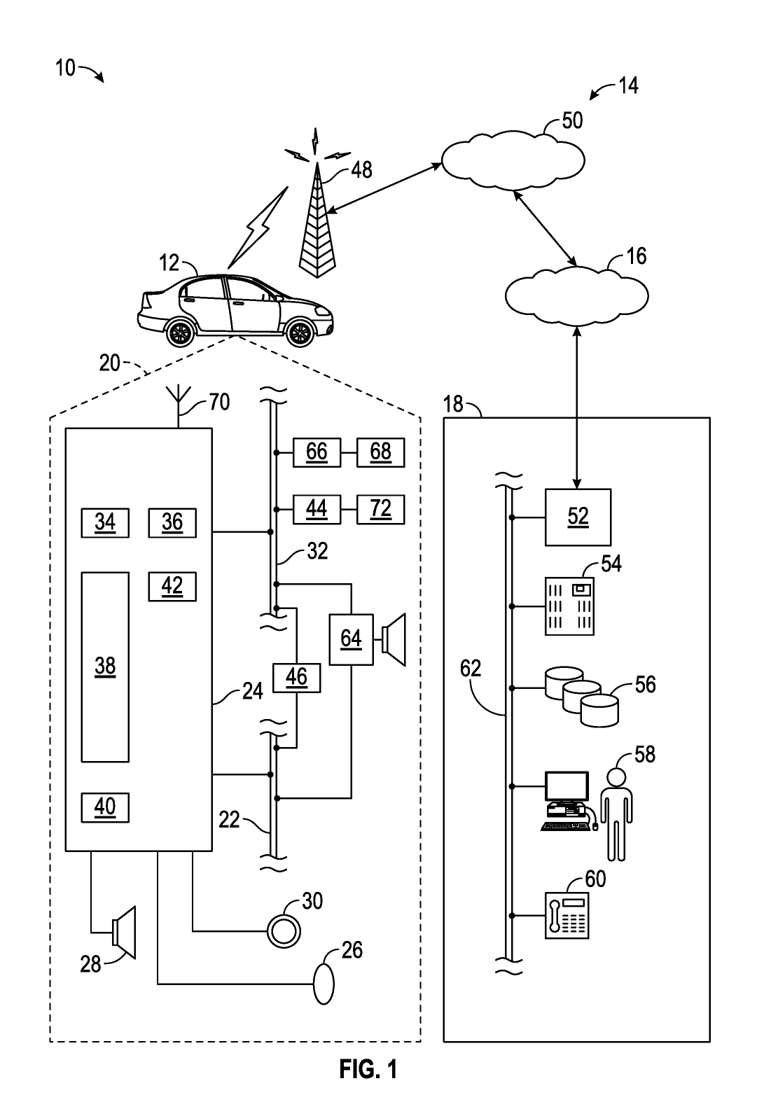

With reference to FIG. 1, there is shown a non-limiting example of a communication system 10 that may be used together with examples of the apparatus/system disclosed herein or to implement examples of the methods disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GNSS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GNSS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc.

Dual mode antenna 70 services the GNSS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a call center 18 that is manned, it will be appreciated that the call center 18 can be any central or remote facility, manned or unmanned, mobile or fixed, to or from which it is desirable to exchange voice and data.

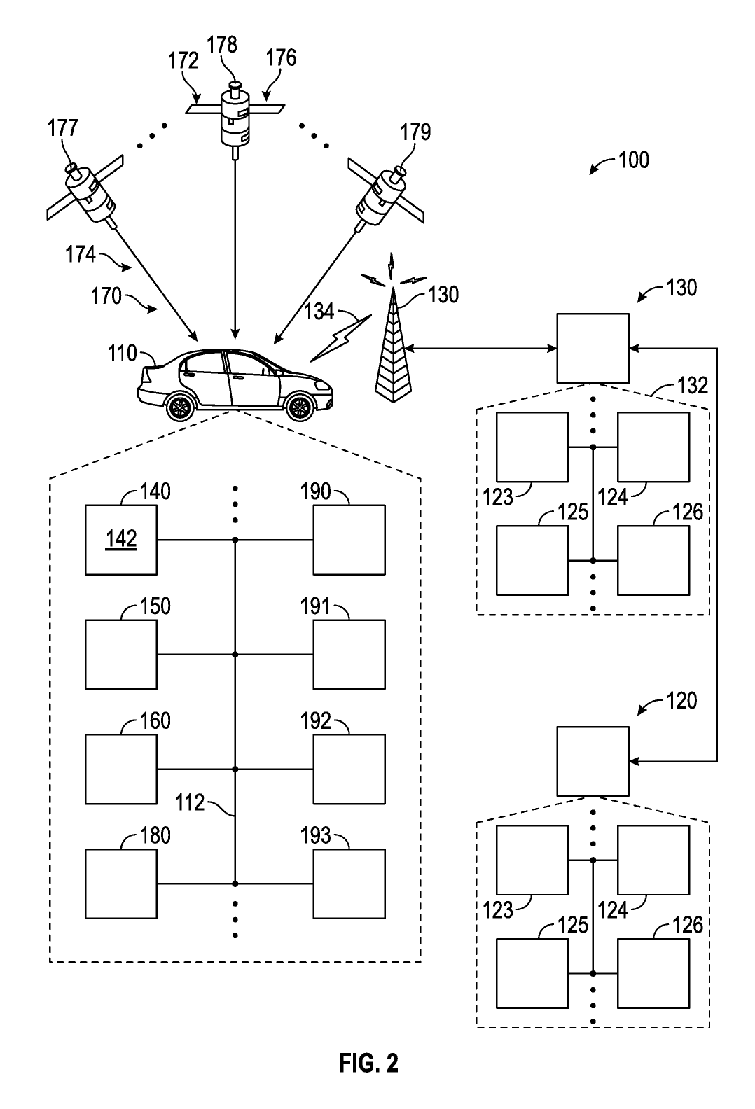

With reference to FIG. 2, there is shown a non-limiting example of a system 100 for locating a vehicle 110. It should be appreciated that the overall architecture, setup and operation, as well as the individual components of the illustrated system 100 are merely exemplary and that differently configured systems may also be utilized to implement the examples of the system 100 disclosed herein. Thus, the following paragraphs, which provide a brief overview of the illustrated system 100, are not intended to be limiting.

The system 100 generally includes the vehicle 110, a remote server 120, and a transmission server 130. The term “server,” as used herein, generally refers to electronic component, as is known to those skilled in the art, such as a computer program or a machine that waits for requests from other machines or software (clients) and responds to them. The system 100 further includes a locating device 140, a receiver 150, and a correction device 160 that are adapted for mounting to the vehicle 110. The term “device,” as used herein, generally refers to electronic component, as is known to those skilled in the art, and is not intended to be limiting. The remote server 120 is configured to report a plurality of correction factors 123-126 for a respective plurality of locations. The transmission server 130 is in communication with the remote server 120 and is configured to buffer the correction factors 123-126 into a burst transmission 132 of the buffered correction factors 123-126 and transmit the burst transmission 132 over a wireless data channel 134.

Vehicle 110 may be any type of mobile vehicle such as a motorcycle, car, truck, recreational vehicle (RV), boat, plane, etc., and is equipped with suitable hardware and software that enables it to communicate over the system 100. The locating device 140, receiver 150, and correction device 160 are adapted to be mounted onboard the vehicle 110 and are operatively coupled to a vehicle bus 112. Examples of suitable vehicle busses 112 include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The locating device 140 is configured to receive position data 170 from a positioning network 172. In a non-limiting embodiment, the locating device 140 is a global navigation satellite system (GNSS) 142 that receives GNSS data 174 from a GNSS satellite network 176 including GNSS satellites 177-179. One skilled in the art will appreciate that while a limited representation of the GNSS system 142 and the GNSS satellite network 176 is disclosed herein, this this disclosure will not limit the understanding of the system 100. Position data 170 is broadcasted from the positioning network 172 and in turn received by the locating device 140 onboard the vehicle 110. The locating device 140 uses the position data 170 to determine an approximate position of the vehicle 110.

The locating device 140 aligns the GNSS data 174 broadcasted by GNSS satellites 177-179 of the GNSS satellite network 176 to an internally generated version of a pseudorandom binary sequence, also contained in the GNSS data 174. As the GNSS data 174 broadcasted by the GNSS satellite 177 travels to the vehicle 110, the GNSS data 174 takes time to reach the locating device 140. Since the GNSS data 174 takes time to reach the locating device 140, the two sequences do not initially coincide; the copy of the GNSS data 174 at GNSS satellite 177-179 is delayed in relation to the copy of the GNSS data 174 at locating device 140. By increasingly delaying the copy at locating device 140, the two copies can eventually be aligned. The correct delay represents the time needed for the GNSS data 174 to reach the locating device 140, and from this the distance from the GNSS satellite 177 can be calculated.

The accuracy of the resulting range measurement, and therefore the accuracy of the approximate position of the vehicle 110, is essentially a function of the ability of the locating device 140 to accurately process GNSS data 174 from the GNSS satellites 177-179. However, error sources introduced into the GNSS data 174 such as non-mitigated ionospheric and tropospheric delays, multipath, satellite clock, and ephemeris errors, etc., can negatively impact the range measurement made by the locating device 140 resulting in less accurate approximate position of the vehicle 110. The accuracy of GNSS positioning is generally given as “accurate to twenty feet,” meaning that an actual position could be anywhere within a twenty foot radius of the determined position. For example, a GNSS position that is accurate to thirty feet is less accurate than a GNSS position that is accurate to ten feet.

Precise Point Positioning (PPP) satellite navigation uses instantaneous state corrections that are broadcasted for all satellite signals available to a device employing GNSS to allow for improved accuracy. The state corrections include corrections for satellite clock, satellite orbit, and ionospheric delays, and tropospheric delays, for example. The specific operation of PPP is not contemplated by this application, however, one skilled in the art will appreciate that some challenges of PPP can be addressed through the use of correction factors 123-126 that compensate for the errors introduced into the GNSS data 174 as discussed above. The generation of the correction factors 123-126 is likewise not contemplated by this application and in a non-limiting embodiment, the correction factors 123-126 may be provided by a third party service.

The correction factors 123-126 allow for improved accuracy when determining the position of the vehicle. However, each correction factor 123-126 is only useful within a specific location or geographic range. Stated differently by way of example, a vehicle 110 traveling in Detroit, Mich. would not want to use a correction factor that is specific to Paris, France. Accordingly, each of the correction factors 123-126 is associated with a location. In a non-limiting example, each correction factor 123-126 may be associated with a location area that is circular and approximately 20 miles in diameter. In a non-limiting example, the locations areas overlap such that as the vehicle 110 travels from one location area to another, the vehicle 110 is always located in an area having a correction factor 123-126.

The remote server 120 reports the plurality of correction factors 123-126 for the respective plurality of locations. While only four correction factors 123-126 are depicted in the remote server 120, one skilled in the art will appreciate that a greater number of correction factors 123-126 may be reported by the remote server 120 without departing from the spirit and the scope of the present application and, as such, the depiction herein is not intended to be limiting. The correction factors 123-126 may be updated in the remote server 120 as more accurate factors become available, as weather conditions change, etc., such that relevant and situationally accurate correction factors 123-126 are broadcasted.

The transmission server 130 buffers the correction factors 123-126 into the burst transmission 132 of buffered correction factors 123-126. The transmission server transmits the burst transmission 132 over the wireless data channel 134 which is in turn received by the receiver 150 on the vehicle 110. One skilled in the art will appreciate that the transmission server 130 and the receiver 150 are configured to communicate wirelessly such that the wireless data channel 134 may be received by the receiver 150. In a non-limiting embodiment, the wireless data channel 134 is transmitted using any suitable encoding or modulation technique, including digital transmission technologies, such as TDMA (time division multiple access), CDMA (code division multiple access), W-CDMA (wideband CDMA), FDMA (frequency division multiple access), OFDMA (orthogonal frequency division multiple access), etc. In a non-limiting embodiment, the burst transmission 132 is a single wireless data transmission that includes all of the buffered correction factors 123-126. Stated differently, in a non-limiting embodiment, the burst transmission 132 transmitted by the transmission server 130 contains buffered copies of all of the correction factors 123-126 in the remote server 120.

As detailed above, conventionally correction factors are broadcasted in a continuous data stream that is updated as newer correction factors become available. When all of the correction factors have been updated, if necessary, the data stream is re-broadcasted. One skilled in the art will appreciate that to ensure optimal PPP accuracy in the location of the vehicle 110 to within, for example 2 meters, the vehicle 110 would need to receive the entire data stream. If a portion of the data stream was not received by the vehicle 110 due to loss of data, poor signal, or actively receiving the data stream mid transmission, the PPP system would need to wait for receipt of a full and complete data stream before the correcting device 160 could determine the refined position.

By buffering the correction factors 123-126 into the burst transmission 132, the transmission server 130 overcomes the issues with a continuous data stream described above. The burst transmission 132 contains all of the buffered correction factors 123-126 and delivers them over a comparatively short time period, relative to the continuous data stream, to the receiver 150. As such, the burst transmission 132 is transmitted over the wireless data channel 134 with a greater bandwidth than the continuous data stream so that all of the correction factors 123-126 are transmitted over a shorter period of time. Stated differently, using a continuous data stream, the correction factors are sequentially broadcasted over a period of time until all of the correction factors are broadcasted. In comparison, the burst transmission 132 allows for all of the correction factors to be transmitted in a shorter period of time relative to the sequentially broadcasted continuous data stream.

The correction device 160 is in communication with the locating device 140 and the receiver 150 over the vehicle bus 112. Using the approximate position of the vehicle 112 from the locating device 140, the correction device 160 extracts a selected correction factor from the burst transmission 132. In a non-limiting example, the correction device 160 uses the approximate position of the vehicle to identify the location that includes the approximate position of the vehicle. For example, in a non-limiting example, if each of the locations are approximately 20 miles in diameter, the correction device 160 determines the location that covers the approximate position of the vehicle. In a non-limiting embodiment, the burst transmission 132 includes location markers that indicate the location associated with each of the buffered correction factors 123-126 transmitted in the burst transmission 132.

The correction device 160 determines a refined position of the vehicle 110 based on the selected correction factor and the approximate position of the vehicle 110. As detailed above, the correction factors 123-126 allow for improved accuracy when determining the refined position of the vehicle 110 by improving the measurements made with the GNSS data 174. In a non-limiting embodiment, the correction device 160 applies a correction filter to the GNSS data 174 based on the selected correction factor. In a non-limiting embodiment, the correction device 160 provides filtered GNSS data to the locating device 140 to determine the refined position.

In a non-limiting embodiment, the burst transmission 132 includes all of the correction factors 123-126 that are valid for the entire planet. In a non-limiting embodiment, the correction device 160 extracts a selected correction factor from the planet wide correction factors 123-126 contained in the burst transmission 132 based on the approximate position of the vehicle 110.

In a non-limiting embodiment, the correction device 160 is implemented in a software application that is hosted on the electronics module (not shown) that includes the locating device 140 and the receiver 150. Both the locating device 140 and the receiver 150 provide real time data to the correction device 160, which runs continuously on the electronics module. In a non-limiting embodiment, the vehicle bus 112 reports the refined position to other vehicle systems on the vehicle bus 112.

In a non-limiting embodiment, the remote server 120 is configured to report a plurality of updated correction factors (not shown) for the respective plurality of locations to the transmission server 130. The updated correction factors may be updated in the remote server 120 as more accurate factors become available, as weather conditions change, etc., such that relevant and situationally accurate correction factors are available to the transmission server 130. In a non-limiting embodiment, the transmission server is configured to buffer the burst transmission with updated correction factors from the remote server 120.

In a non-limiting embodiment, the correction factors 123-126 are factors selected from the group consisting of: a satellite orbit correction factor, a satellite range factor, a model of satellite orbit model factor, an atomic clock correction factor, an ionosphere signal delay factor, a troposphere signal delay factor, or a combination thereof. In this way, the present disclosure contemplates that each of the correction factors 123-126 may contain any number of individual factors to be used in the determination of the refined position.

In a non-limiting embodiment, the vehicle 110 further includes a transmitter 180 in communication with the bus 112. The transmitter 180 is configured to transmit a request signal to the transmission server 130 over the wireless data channel 134. One skilled in the art will appreciate that similar to the transmission server 130 and the receiver 150, the transmitter 180 is configured to communicate wirelessly over the wireless data channel 134. In a non-limiting embodiment, the transmission server 130 is configured to transmit the burst transmission 132 based on the request signal from the transmitter 180.

In a non-limiting embodiment, the correction device 160 is configured to validate the burst transmission 132 to ensure that the entirety of the burst transmission 132 was successfully received by the receiver 150. If the correction device 160 does not validate the entirety of the burst transmission 132, the transmitter 180 transmits the request signal to the transmission server 130 to re-transmit the burst transmission 132.

In a non-limiting embodiment, the vehicle 110 further includes a vehicle control system 190-193 in communication with the bus 112 which is provided with the refined position by the correction device 160. In a non-limiting embodiment, the vehicle 110 includes a cruise control system 190, a navigation system 191, an autonomous driving system 192, and a vehicle to vehicle communication system 193.

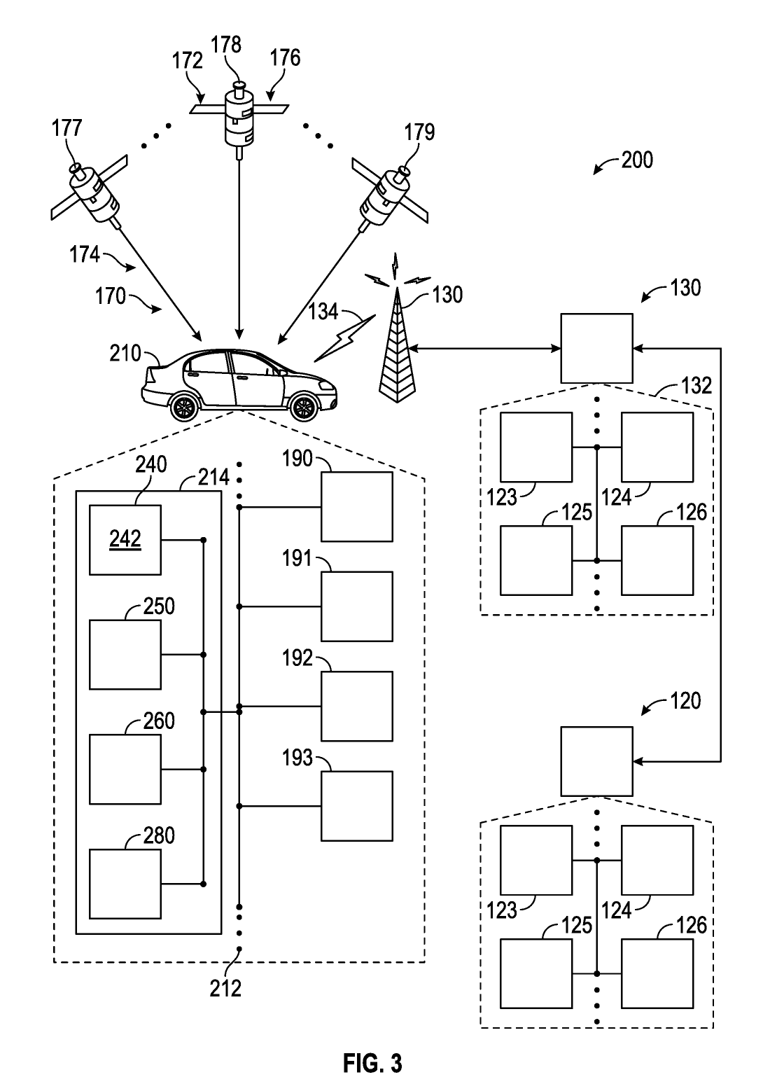

With reference now to FIG. 3 and with continued reference to FIG. 2, there is shown a non-limiting example of a system 200 for locating a vehicle 210. It should be appreciated that the overall architecture, setup and operation, as well as the individual components of the illustrated system 200 are merely exemplary and that differently configured systems may also be utilized to implement the examples of the system 200 disclosed herein. Thus, the following paragraphs, which provide a brief overview of the illustrated system 200, are not intended to be limiting. As similar components are used in the system 200 relative to the system 100, similar reference numerals will be used and the description of system 200 will focus on the differences relative to the system 100.

The system 200 generally includes the vehicle 210, the remote server 120, and the transmission server 130. The vehicle 210 includes a telematics control unit 214. Further to the telematics unit 24 of FIG. 1, the telematics control unit 214 includes a locating device 240, a receiver 250, a correction device 260, and a transmitter 280. The remote server 120 is configured to report a plurality of correction factors 123-126 for a respective plurality of locations. The transmission server 130 is in communication with the remote server 120 and is configured to buffer the correction factors 123-126 into a burst transmission 132 of the buffered correction factors 123-126 and transmit the burst transmission 132 over the wireless data channel 134.

Vehicle 210 may be any type of mobile vehicle such as a motorcycle, car, truck, recreational vehicle (RV), boat, plane, etc., and is equipped with suitable hardware and software that enables it to communicate over the system 200. The locating device 240, receiver 250, correction device 260, and transmitter 280 are onboard the vehicle 210 and operatively coupled to a vehicle bus 212. Examples of suitable vehicle busses 212 include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The locating device 240 is configured to receive position data 170 from the positioning network 172. In a non-limiting embodiment, the locating device 240 is the global navigation satellite system (GNSS) 242 that receives GNSS data 174 from the GNSS satellite network 176 including GNSS satellites 177-179. One skilled in the art will appreciate that while a limited representation of the GNSS system 242 and the GNSS satellite network 176 is disclosed herein, this this disclosure will not limit the understanding of the system 200. Position data 170 is broadcasted from the positioning network 172 and in turn received by the locating device 240 onboard the vehicle 210. The locating device 240 uses the position data 170 to determine an approximate position of the vehicle 210.

The remote server 120 reports the plurality of correction factors 123-126 for the respective plurality of locations. While only four correction factors 123-126 are depicted in the remote server 120, one skilled in the art will appreciate that a greater number of correction factors 123-126 may be reported by the remote server 120 without departing from the spirit and the scope of the present application and, as such, the depiction herein is not intended to be limiting. The correction factors 123-126 may be updated in the remote server 120 as more accurate factors become available, as weather conditions change, etc., such that relevant and situationally accurate correction factors 123-126 are broadcasted.

The transmission server 130 buffers the correction factors 123-126 into the burst transmission 132 of buffered correction factors 123-126. The transmission server transmits the burst transmission 132 over the wireless data channel 134 which is in turn received by the receiver 150 on the vehicle 110. One skilled in the art will appreciate that the transmission server 130 and the receiver 150 are configured to communicate wirelessly such that the wireless data channel 134 may be received by the receiver 150. In a non-limiting embodiment, the wireless data channel 134 is transmitted using any suitable encoding or modulation technique, including digital transmission technologies, such as TDMA (time division multiple access), CDMA (code division multiple access), W-CDMA (wideband CDMA), FDMA (frequency division multiple access), OFDMA (orthogonal frequency division multiple access), etc. In a non-limiting embodiment, the burst transmission 132 is a single wireless data transmission that includes all of the buffered correction factors 123-126. Stated differently, in a non-limiting embodiment, the burst transmission 132 transmitted by the transmission server 130 contains buffered copies of all of the correction factors 123-126 in the remote server 120.

The correction device 260 is in communication with the locating device 240, the receiver 250, and the transmitter 280 over the vehicle bus 212. Using the approximate position of the vehicle 210 from the locating device 240, the correction device 260 extracts a selected correction factor from the burst transmission 132. In a non-limiting example, the correction device 260 uses the approximate position of the vehicle to identify the location that includes the approximate position of the vehicle. For example, in a non-limiting example, if each of the locations are approximately 20 miles in diameter, the correction device 260 determines the location that covers the approximate position of the vehicle. In a non-limiting embodiment, the burst transmission 132 includes location markers that indicate the location associated with each of the buffered correction factors 123-126 transmitted in the burst transmission 132.

The correction device 260 determines a refined position of the vehicle 210 based on the selected correction factor and the approximate position of the vehicle 210. As detailed above, the correction factors 123-126 allow for improved accuracy when determining the refined position of the vehicle 210 by improving the measurements made with the GNSS data 174. In a non-limiting embodiment, the correction device 260 applies a correction filter to the GNSS data 174 based on the selected correction factor. In a non-limiting embodiment, the correction device 260 provides filtered GNSS data to the locating device 240 to determine the refined position.

In a non-limiting embodiment, the burst transmission 132 includes all of the correction factors 123-126 that are valid for the entire planet. In a non-limiting embodiment, the correction device 260 extracts a selected correction factor from the planet wide correction factors 123-126 contained in the burst transmission 132 based on the approximate position of the vehicle 210.

In a non-limiting embodiment, the correction device 260 is implemented a software application that is hosted on the electronics module (not shown) that includes the locating device 240 and the receiver 250. Both the locating device 240 and the receiver 250 provide real time data to the correction device 260, which runs continuously on the electronics module. In a non-limiting embodiment, the vehicle bus 212 reports the refined position to other vehicle systems on the vehicle bus 212.

In a non-limiting embodiment, the remote server 120 is configured to report a plurality of updated correction factors (not shown) for the respective plurality of locations to the transmission server 130. The updated correction factors may be updated in the remote server 120 as more accurate factors become available, as weather conditions change, etc., such that relevant and situationally accurate correction factors are available to the transmission server 130. In a non-limiting embodiment, the transmission server is configured to buffer the burst transmission with updated correction factors from the remote server 120.

In a non-limiting embodiment, the correction factors 123-126 are factors selected from the group consisting of: a satellite orbit correction factor, a satellite range factor, a model of satellite orbit model factor, an atomic clock correction factor, an ionosphere signal delay factor, a troposphere signal delay factor, or a combination thereof. In this way, the present disclosure contemplates that each of the correction factors 123-126 may contain any number of individual factors to be used in the determination of the refined position.

In a non-limiting embodiment, the transmitter 280 is configured to transmit a request signal to the transmission server 130 over the wireless data channel 134. One skilled in the art will appreciate that similar to the transmission server 130 and the receiver 250, the transmitter 280 is configured to communicate wirelessly over the wireless data channel 134. In a non-limiting embodiment, the transmission server 130 is configured to transmit the burst transmission 132 based on the request signal from the transmitter 280.

In a non-limiting embodiment, the correction device 260 is configured to validate the burst transmission 132 to ensure that the entirety of the burst transmission 132 was successfully received by the receiver 250. If the correction device 260 does not validate the entirety of the burst transmission 132, the transmitter 280 transmits the request signal to the transmission server 130 to re-transmit the burst transmission 132.

In a non-limiting embodiment, the vehicle 210 further includes a vehicle control system 290-293 in communication with the bus 212 which is provided with the refined position by the correction device 260. In a non-limiting embodiment, the vehicle 210 includes a cruise control system 290, a navigation system 291, an autonomous driving system 292, and a vehicle to vehicle communication system 293.

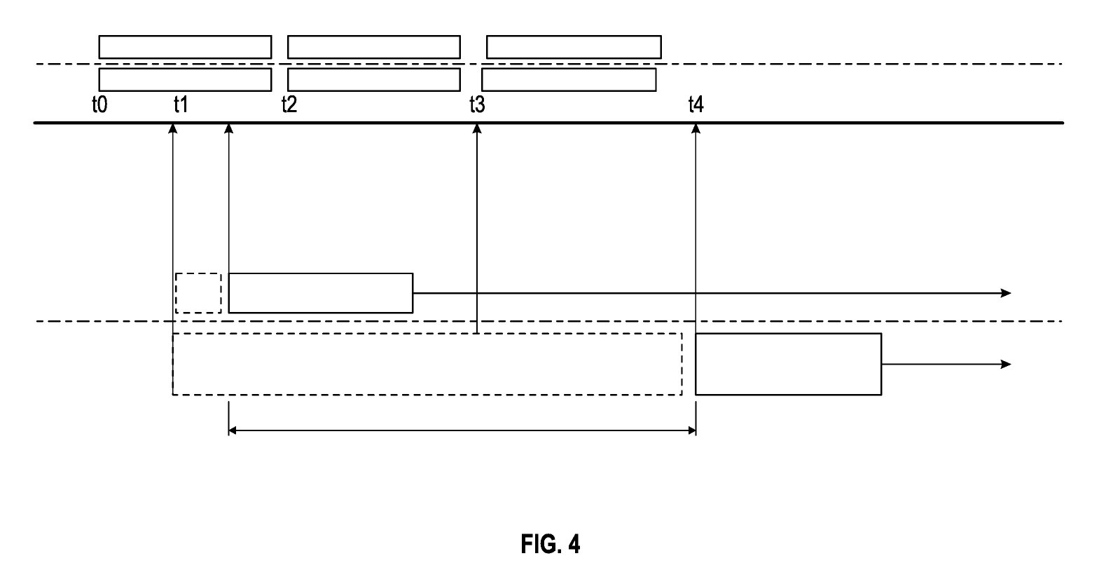

Referring now to FIGS. 4-6, and with continued reference to FIGS. 2-3, a series of diagrams illustrate non-limiting examples of the operation of the systems 100, 200 for locating a vehicle 110, 210 according an embodiment. FIGS. 4-6 illustrate a comparison between the operation of a conventional PPP locating system utilizing a continuous data stream of correction factors (prior art system) and the operation of a vehicle 110, 210 having the systems 100, 200 detailed above. Throughout the description and for ease of understanding, it should be appreciated that when the systems have achieved two meter accuracy, they are using PPP to achieve the refined position as described above.

The time line includes time markers, t0-t4, which are used to indicate how the prior art system and the systems 100, 200 operate over time, from left to right along the time line. The time markers should not be interpreted as limiting and are included for understanding.

Above the time line are availability and validity of correction factors with respect to a period of time or epoch. By way of example, from t0 to t2, the correction factors from epoch 1 are continuously streamed by the prior art system. In the systems 100, 200, from t0 to t2, the buffered correction factors from epoch 0 are buffered as the burst transmission 132 and may be transmitted by the transmission server 130. One skilled in the art will appreciate that the correction factors are updated along with the epochs. Stated differently, the correction factors in epoch 3 are the updated correction factors with respect to epoch 2, and so on.

Throughout FIGS. 4-6, times when the systems 100, 200 or the prior art systems are operating with two meter accuracy will be depicted with a box with a solid line. When the systems 100, 200 or the prior art systems are not operating with two meter accuracy, a box with a dashed line will be used.

FIG. 4 depicts a situation in which the vehicle 110, 210 and the prior art vehicle come online to perform PPP locating in the middle of an epoch stream. In a non-limiting example, FIG. 4 depicts a situation in which a vehicle pulls onto a highway and engages a system that requires PPP locating, such as an autonomous driving system. Accordingly, it is desirable to achieve PPP locating at two meter as quickly as possible. The benefits of the systems 100, 200 with respect to the time to achieve two meter accuracy relative to the prior art system will now be described.

At t0, in the systems 100, 200, the correction factors from epoch 0 are buffered in the burst transmission 132 and the transmission server 130 is ready to transmit the burst transmission 132. The vehicle 110, 210 comes online at t1 and shortly thereafter receives the burst transmission 132 from the transmission server. A short time thereafter, having received the entire burst transmission 132, the correction device extracts the selected correction factor from the burst transmission 132 and determines the refined position of the vehicle 110, 210 based on the selected correction factor and the approximate position of the vehicle 110, 210. The time between the vehicle coming online and achieving two meter accuracy is shown as taking time on the Time Line to allow for comparison and account for the speed of the burst transmission 132 and the processing speed of the system 100, 200 and should not be interpreted as limiting.

In the prior art system, at t0, the stream of epoch 1 correction factors begins. At t1, the prior art system comes online midway through the stream of epoch 1 and, consequently, continues to receive epoch 1 correction factors through the stream of epoch 2 correction factors. As such, the prior art system is unable to correctly receive a complete set of correction factors until the epoch 3 stream begins at t3. At t4 and after receiving the entirety of the epoch 3 stream, the prior art system achieves two meter accuracy.

As shown by the line at the bottom of FIG. 4, the system 100, 200 achieved two meter accuracy more than two epochs before the prior art system. In a non-limiting example, if each epoch has a duration of 30 seconds, the system 100, 200 would achieve two meter accuracy over a minute before the prior art system.

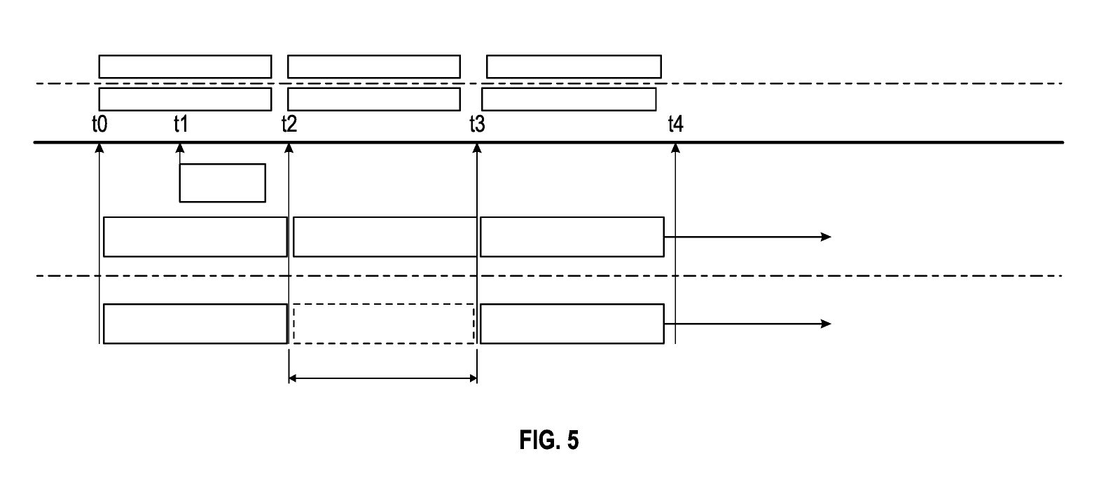

Referring now to FIG. 5 and with continued reference to FIGS. 2-4, FIG. 5 depicts a situation in which the vehicle 110, 210 and the prior art vehicle have achieved two meter accuracy and encounter a data break in the middle of an epoch stream. In a non-limiting example, FIG. 5 depicts a situation in which a vehicle has two meter accurate PPP locating, is operating the system that requires PPP locating, such as an autonomous driving system, and loses a data connection. The impacts of this data break on the systems 100, 200 with respect to the prior art system will now be described.

At t0, the vehicle 110, 210 is operating with two meter accuracy using epoch 0 correction factors that were received from the burst transmission 132 at t0. At t1, the data break occurs. However, the burst transmission 132 at t0 communicated all of the correction factors to the system 100, 200, so the data break has no impact on the two meter accuracy of the system 100, 200. The system 100, 200 continues and receives the subsequent burst transmissions 132 at t2 and t3 and maintains two meter accuracy throughout the Time Line.

In the prior art system, at t0, the vehicle is operating with two meter accuracy using the epoch 0 corrections factors that were received in a previous epoch 0 stream. The system 100, 200 is also receiving the stream of epoch 1 correction factors beginning at t0. At t1, the data break occurs and the prior art system stops receiving the epoch 1 stream. At t2, the prior art system loses two meter accuracy because the complete correction factors from epoch 1 were not received. As such, the prior art system is unable achieve two meter accuracy until it has received an entire stream of correction factors. From t2 until t3, the prior art system receives the entirety of the epoch 2 stream and achieves two meter accuracy with the epoch 2 data starting at t3.

As shown by the line at the bottom of FIG. 5, the system 100, 200 maintained two meter accuracy from t2 through t3 and was unaffected by the data break. In contrast, the prior art system was unable to maintain two meter accuracy because the data break interrupted the epoch 1 stream. In the non-limiting example of FIG. 5, the prior art system lost two meter accuracy only for the time between t2 and t3, however, one skilled in the art will appreciate that subsequent and continued data breaks could continually render the prior art system unable to achieve two meter accuracy.

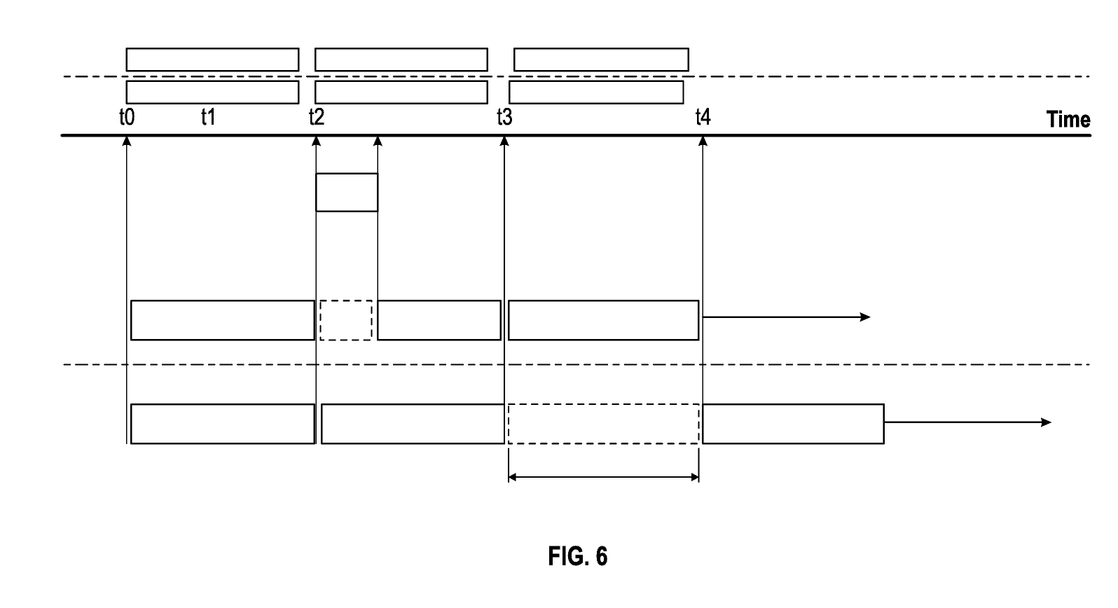

Referring now to FIG. 6 and with continued reference to FIGS. 2-5, FIG. 6 depicts a situation in which the vehicle 110, 210 and the prior art vehicle have achieved two meter accuracy and encounter a data break in the middle of the burst transmission 132. In a non-limiting example, FIG. 6 depicts a situation in which a vehicle has two meter accurate PPP locating, is operating the system that requires PPP locating, such as an autonomous driving system, and loses a data connection during the transmittal of the burst transmission 132. The impacts of this data break on the systems 100, 200 with respect to the prior art system will now be described.

At t0, the vehicle 110, 210 is operating with two meter accuracy using epoch 0 correction factors that were received from the burst transmission 132 at t0. At t2, the data break occurs while the vehicle 110, 210 is receiving the burst transmission 132 of epoch 1 data. Accordingly, the system 100, 200 is unable to maintain two meter accuracy and immediately transmits a request for a new burst transmission 132 of epoch 1 data. Shortly after receiving the retransmitted epoch 1 burst transmission 132, the system 100, 200 regains two meter accuracy. The system 100, 200 continues and receives the subsequent burst transmission 132 at t3 and maintains two meter accuracy throughout the remainder of the Time Line. In this non-limiting example, the system 100, 200 lost two meter accuracy for only the period of time between the data break and shortly after the receipt of the retransmitted burst transmission 132. This down time is less than the duration of an epoch.

In the prior art system, at t0, the vehicle is operating with two meter accuracy using the epoch 0 corrections factors that were received in a previous epoch 0 stream. The prior art system is also receiving the stream of epoch 1 correction factors beginning at t0. At t2, the data break occurs and the prior art system is unable to receive the epoch 2 stream. However, having already received the epoch 1 stream, the prior art system maintains two meter accuracy until t3. At t3, the prior art system loses two meter accuracy because the complete correction factors from epoch 2 were not received. As such, the prior art system is unable achieve two meter accuracy until it has received an entire stream of correction factors. From t3 until t4, the prior art system receives the entirety of the epoch 3 stream and achieves two meter accuracy with the epoch 3 data starting at t4.

As shown by the line at the bottom of FIG. 6, the prior art system was unable to maintain two meter accuracy because the data break prevented the transmission of the epoch 2 stream. In the non-limiting example of FIG. 6, the prior art system lost two meter accuracy for the time of the entire epoch between t3 and t4. In contrast, the system 100, 200 only lost two meter accuracy for a portion of the epoch after t2 until the new burst transmission 132 was received. As such, in the unlikely situation that a data break occurs during the brief period of time that the vehicle 110, 210 is receiving the burst transmission 132, the system 100, 200 is able to quickly come back online rather than waiting for the next epoch stream.

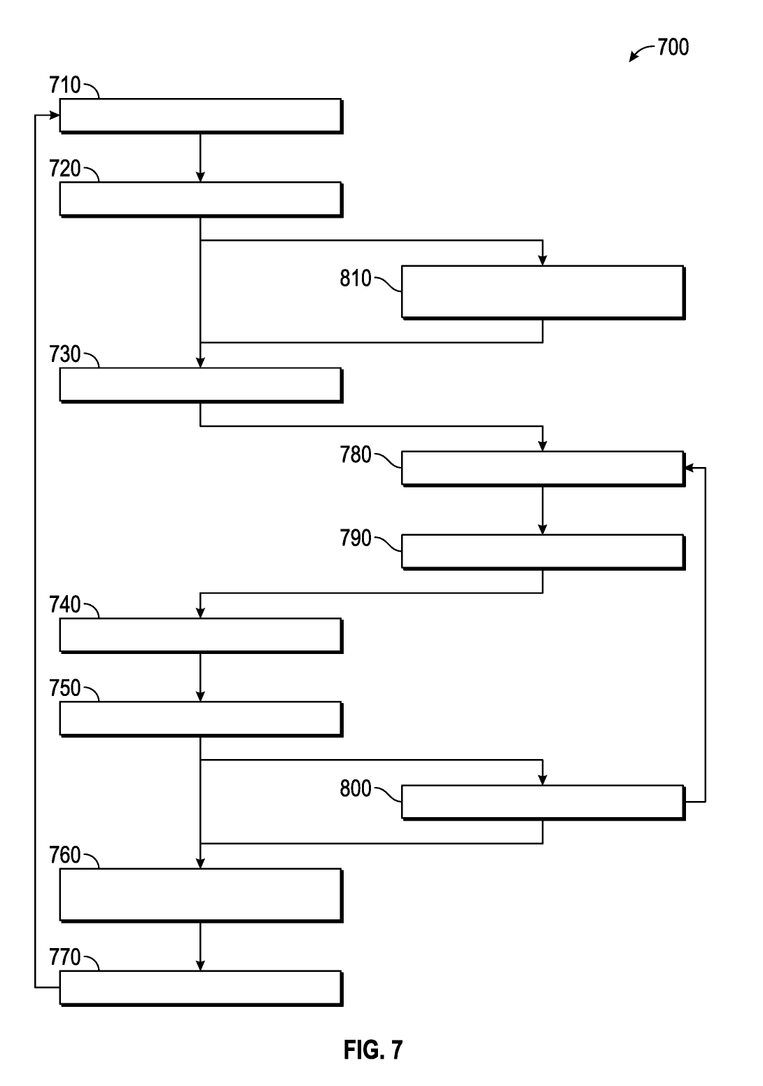

Referring now to FIG. 7, and with continued reference to FIGS. 2-6, a flowchart illustrates a method 700 for locating a vehicle in accordance with the present disclosure. In a non-limiting embodiment, the method 700 is performed by the systems 100, 200 detailed above. As can be appreciated in light of the disclosure, the order of operation within the method 700 is not limited to the sequential execution as illustrated in FIG. 7, but may be performed in one or more varying orders as applicable and in accordance with the requirements of a given application.

In various exemplary embodiments, the method 700 is run based on predetermined events, and/or can run continuously during operation of the systems 100, 200. The method 700 starts at 710 with receiving position data with a locating device. In a non-limiting embodiment, a locating device 140, 240 receives position data 170.

At 720, the method 700 determines an approximate position of the vehicle, based on the position data. In a non-limiting embodiment, the approximate position of the vehicle 110, 210 is determined based on the position data 170.

At 730, a plurality of correction factors are buffered into a burst transmission with a transmission server. The buffered plurality of correction factors correspond to a respective plurality of locations. In a non-limiting embodiment, the plurality of correction factors 123-126 are buffered into the burst transmission 132 with the transmission server 130 and the buffered plurality of correction factors 123-126 correspond to a respective plurality of locations.

At 740, the transmission server transmits the burst transmission. In a non-limiting embodiment, the transmission server 130 transmits the burst transmission 132 over the wireless communication channel 134.

At 750, a receiver on the vehicle receives the burst transmission. In a non-limiting embodiment, the receiver 150, 250 receives the burst transmission 132 over the wireless communication channel 134.

At 760, a selected correction factor is extracted from the burst transmission based on the approximate position. In a non-limiting embodiment, the selected correction faction is extracted from the burst transmission 132 based on the approximate position determined by the locating device 140, 240.

At 770, a correction device determines a refined position of the vehicle based on the selected correction factor and the approximate position. In a non-limiting embodiment, the correction device 160, 260 determines the refined position of the vehicle 110, 210, based on the selected correction factor and the approximate position. The method 700 then proceeds to 710 determine another refined position as necessary.

In a non-limiting embodiment, the method 700 further includes 780 and transmits a request signal with a transmitter on the vehicle. In a non-limiting embodiment, the vehicle 110, 210 includes the transmitter 180, 280 which is configured to transmit the request signal.

In a non-limiting embodiment, the method 700 further includes 790 and the transmission server receives the request signal. In a non-limiting embodiment, the transmission server 130 receives the request signal from the transmitter 180, 280. The method 700 then proceeds to 740 and transmits the burst transmission based on the transmission server receiving the request signal.

In a non-limiting embodiment, the method 700 further includes 800 and validates the burst transmission. In a non-embodiment, the correction device 160, 260 validates the burst transmission 132. If the burst transmission is not validated, the method 700 proceeds to 780 and transmits the request signal. If the burst transmission is validated, the method 700 proceeds to 760 and extracts the selected correction factor from the burst transmission.

In a non-limiting embodiment, the method 700 further includes 810 and buffers the burst transmission with updated correction factors. In a non-limiting embodiment, the transmission server 130 buffers the burst transmission 132 with updated correction factors. The method then proceeds to 730 and buffers the burst transmission 132.

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

1. A system for locating a vehicle comprising:
a locating device adapted for mounting to the vehicle, the locating device being configured to receive position data and to determine an approximate position of the vehicle when mounted thereto;
a remote server configured to report a plurality of correction factors for a respective plurality of locations;
a transmission server configured to buffer the plurality of correction factors into a burst transmission and transmit the burst transmission over a wireless data channel;
a receiver adapted for mounting to the vehicle, the receiver being configured to receive the burst transmission from the transmission server over the wireless data channel; and
a correction device adapted for mounting to the vehicle, the correction device being configured to extract a selected correction factor from the burst transmission based on the approximate position and to determine a refined position of the vehicle based on the selected correction factor and the approximate position.

2. The system of claim 1, wherein the burst transmission consists of a single wireless data transmission that includes all of the plurality of correction factors.

3. The system of claim 1, wherein the locating device comprises a global navigation satellite system, the position data comprises a global navigation satellite signal, and the correction device filters the position data based on the selected correction factor.

4. The system of claim 1, wherein the plurality of correction factors are selected from the group consisting of: a satellite orbit correction factor, a satellite range factor, a model of satellite orbit model factor, an atomic clock correction factor, an ionosphere signal delay factor, a troposphere signal delay factor, or a combination thereof.

5. The system of claim 1, wherein the transmission server is configured to buffer the burst transmission with a plurality of updated correction factors from the remote server.

6. The system of claim 1, further comprising a transmitter configured to transmit a request signal to the transmission server over the wireless data channel, wherein the transmission server is configured to transmit the burst transmission based on the request signal.

7. The system of claim 6, wherein the correction device is configured to validate the burst transmission and the transmitter is configured to transmit the request signal based on the validation.

8. A vehicle comprising:
a telematics control unit comprising:
a locating device configured to receive position data and determine an approximate position of the vehicle;
a receiver configured to receive a burst transmission from a transmission server, the burst transmission buffered with a plurality of correction factors for a respective plurality of locations; and
a correction device configured to extract a selected correction factor from the burst transmission based on the approximate position and determine a refined position of the vehicle based on the selected correction factor and the approximate position.

9. The vehicle of claim 8, wherein the burst transmission consists of a single wireless data transmission that includes all of the plurality of correction factors.

10. The vehicle of claim 8, wherein the locating device comprises a global navigation satellite system, the position data comprises a global navigation satellite signal, and the correction device filters the position data based on the selected correction factor.

11. The vehicle of claim 8, wherein the plurality of correction factors are selected from the group consisting of: a satellite orbit correction factor, a satellite range factor, a satellite orbit model factor, an atomic clock correction factor, an ionosphere signal delay factor, a troposphere signal delay factor, or a combination thereof.

12. The vehicle of claim 8, wherein the transmission server is configured to buffer the burst transmission with a plurality of updated correction factors from a remote server.

13. The vehicle of claim 8, further comprising a transmitter in the telematics control unit configured to transmit a request signal to the transmission server, wherein the transmission server is configured to transmit the burst transmission based on the request signal.

14. The vehicle of claim 13, wherein the correction device is configured to validate the burst transmission and the transmitter is configured to transmit the request signal based on the validation.

15. The vehicle of claim 8, further comprising a vehicle control system, wherein the vehicle control system is provided with the refined position.

16. The vehicle of claim 15, wherein the vehicle control system includes at least one of a cruise control system, a navigation system, an autonomous driving system, and a vehicle to vehicle communication system.

17. A method of locating a vehicle comprising:
receiving position data with a locating device;
determining an approximate position of the vehicle based on the position data;
buffering a plurality of correction factors into a burst transmission with a transmission server, the plurality of correction factors corresponding to a respective plurality of locations;
transmitting the burst transmission with the transmission server;
receiving the burst transmission with a receiver on the vehicle;
extracting a selected correction factor from the burst transmission based on the approximate position; and
determining a refined position of the vehicle with a correction device on the vehicle, the refined position of the vehicle based on the selected correction factor and the approximate position.

18. The method of claim 17, further comprising:
transmitting a request signal with a transmitter on the vehicle; and
receiving, by the transmission server, the request signal,
wherein the transmitting of the burst transmission is based on the transmission server receiving the request signal.

19. The method of claim 18, further comprising:
validating the burst transmission; and
transmitting the request signal based on the validation.

20. The method of claim 17, further comprising:
buffering the burst transmission with updated correction factors.
